(19) United States
(12) Patent Application Publication
(10) Pub. No.: US 2007/0052341 A1
(43) Pub. Date: Mar. 8, 2007

(54) Image display device

(76) Inventors: Daisuke Imafuku, Fujisawa (JP); Hiroki Yoshikawa, Hiratsuka (JP); Tetsu Ohishi, Hiratsuka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/452,373

(22) Filed: Jun. 14, 2006

(30) Foreign Application Priority Data
Sep. 2, 2005 (JP) 2005-254294

(51) Int. Cl. H01J 1/62

(52) U.S. Cl. 313/486

(57) ABSTRACT

The invention provides a technology suited to suppress decrease in the brightness of an image while preventing reduction in the contrast of the image caused by external light coming from the outside (from the viewer side of the image) of a screen. An image display surface (screen) of a projection type display device is provided with a front protective sheet including an optical filter member for absorbing specific wavelengths in the external light, especially among peak wavelengths of a three-wavelength fluorescent lamp. Moreover, LED's of three colors are used as a light source for forming an image. At least one of these LED's emits a light of a different wavelength from a peak wavelength that the front protective sheet absorbs. By this configuration, it is possible to prevent reduction in the contrast of an image caused by external light without decreasing the brightness of the image display device.

### BACKGROUND OF THE INVENTION

1. Field of the Invention

This invention relates to an image display device, specifically to an image display device that underwent refinements to reduce degradation in quality of image caused by external light.

2. Description of the Related Art

As a conventional technology of suppressing degradation in the quality of image by external light (reduction in the contrast) in the image display device, such as a projection type display device, for example, there is known the image display device described in Patent document 1 (JPH10-186270A (Paragraph numbers 0077-0084, FIGS. 20 to 24)). This is a projection type display device whose screen is provided with an optical filter that selectively attenuates lights having wavelengths between peak wavelengths in an emission spectrum distribution of an image light of red, an emission spectrum distribution of an image light of blue, and an emission spectrum distribution of an image light of green. This optical filter selectively attenuates external lights having wavelengths between primary wavelengths of the above-mentioned peak energies and suppresses reduction in the contrast caused by reflection of the external lights while controlling decrease in brightness of the image.

### SUMMARY OF THE INVENTION

The above-mentioned conventional technology may be effective in the case where peak wavelengths of red, blue, and green components included in the external light (that is, in the case where the peak wavelengths of red, blue, and green components included in the external light are between the peak wavelengths of red, blue, and green components included in image light) are different from the peak wavelengths in several colors of an image light. However, in the case where one or more of the peak wavelengths in several colors of an image light are almost equal to the peak wavelengths of red, blue, and green components included in the external light, it is difficult to absorb external lights excellently and at the same time control attenuation of the image light even if using an optical element having a filter characteristic as described above. In particular, in a three-wavelength fluorescent lamp that is a typical source of external lights, it is often the case that the peak wavelengths of RGB colors thereof are almost equal to the peak wavelengths in several colors of the image light. Therefore, under such an external light, it is preferable to prevent the reduction in the contrast caused by the external light and at the same time control decrease in the brightness of the image.

The present invention is made in view of the problem as described above, and has its object to provide a suitable technology to prevent reduction in the contrast by external light while controlling decrease in the brightness of the image.

In order to attain the above-mentioned object, this invention features a configuration in which a peak wavelength of at least one specific color among peak wavelengths of red, blue, and green lights in the emission spectrum distribution is differentiated from the peak wavelength of the specific color in the emission spectrum distribution of external lights. In other words, this invention features a configuration in which a light source for emitting a light whose peak wavelength is different from the peak wavelength of the external light (for a certain specific color) is used as a light source for image formation. Preferably, the above-mentioned specific color is green having a high visibility, but green and red may be used.

More specifically, at least three kinds of light-emitting diodes for emitting three colors of lights of red, blue, and green are used as the above-mentioned light source. Moreover, a peak wavelength of light emitted from the light-emitting diode of a specific color among them is differentiated from the peak wavelength of the above-mentioned specific color in the emission spectrum distribution of the three-wavelength florescent lamp. Furthermore, an optical filter member that absorbs the light having the peak wavelength of the above-mentioned specific color emitted from the three-wavelength fluorescent lamp more largely than the light from the light-emitting diode of the above-mentioned specific color is provided to the image display device. In the case where an imaged is play device is a projection type display device for enlarging and projecting an image on the screen, it is preferable that this optical filter member is provided on the screen.

When the screen is provided with the above-mentioned optical filter member, the filter member may be provided on a front sheet that is a constituent element of the screen or on a front protective sheet. Alternatively, a wavelength selective film as an optical filter member may be glued on the image observation side surface of the screen.

According to this invention, it becomes possible to prevent reduction in the contrast of an image caused by external light while controlling decrease in the brightness of the image.

### BRIEF DESCRIPTION OF THE DRAWINGS

FIG. 1 is an illustration showing one example of a projection type display device.

FIG. 2 is a transmittance characteristic diagram of an optical filter member according to this embodiment.

FIG. 3 is a diagram of an emission spectrum distribution of external light of a three-wavelength fluorescent lamp.

FIG. 4 is a diagram showing one example of a transmission type screen.

FIG. 5 is a diagram showing one example of the emission spectrum distribution of a light source used in this embodiment.

FIG. 6 is a diagram showing another example of the emission spectrum distribution of the light source used in this embodiment.

FIG. 7 is a diagram showing one example of an image source of a projection type display device.

FIG. 8 is a diagram showing one example of a light source drive circuit.

### DETAILED DESCRIPTION OF THE PREFERRED EMBODIMENT

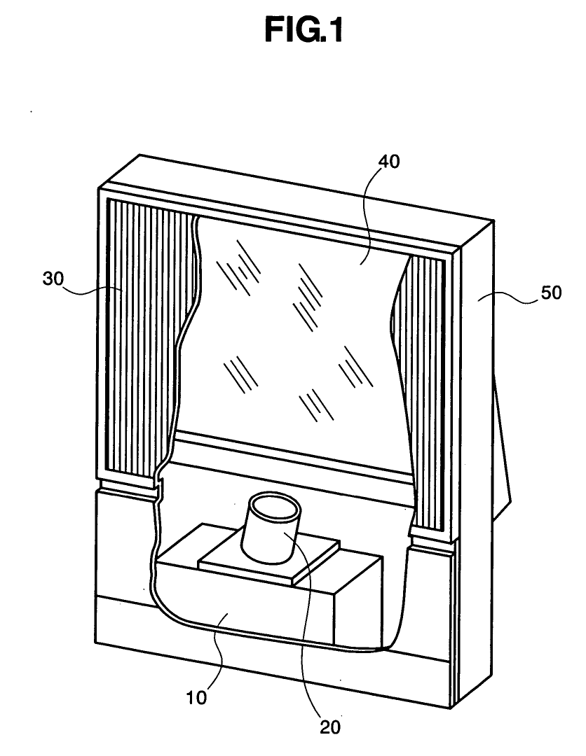

Hereafter, embodiments of this invention will be described with reference to the drawings. First, using FIG. 1, outline of an image display device to which this invention is applied will be explained taking a projection type display device as an example. FIG. 1 is a partially sectional perspective view of the image display device to which this invention may be applied. An image source 10 includes a light source composed of LED's and a display element that forms an image by modulating lights from this light source and is constructed with, for example, a reflection type or transmission type liquid crystal panel. A projector lens 20 enlarges an image from the image source 10. The image enlarged by the projector lens 20 is guided to a reflecting mirror 40 and projected on a transmission type screen 30 after being reflected by this reflecting mirror 40. By this mechanism, the enlarged image is displayed on the transmission type screen 30. That is, in this example, the image observation side surface of the transmission type screen 30 serves as a display surface. Incidentally, the image source 10, the projector lens 20, the transmission type screen 30, and the reflecting mirror 40 described above are housed inside a case 50 and fixed on predetermined positions.

Next, one example of the image source 10 will be explained using FIG. 7. In this example, three kinds of light-emitting diodes (LED's) each of which emits light of one of RGB colors are used as the light source and a transmission type liquid crystal (LCD) panel is used as a display element. The image source 10 exemplified in FIG. 7 has an LCD (Liquid Crystal Display) panel 109 composed of a plurality of pixels arranged in the form of a matrix, an LCD driver 108 for driving this LCD panel 109, a light source 100, a backlight drive control unit 106 for driving this light source 100, and a photosensor 107. The light source 100 is composed of a plurality of LED groups each of which is an area of the whole area divided in a vertical direction and turns on/off independently, that is, an LED group 101, an LED group 102, an LED group 103, and an LED group 104. Note that, although FIG. 7 is explaining a case where the whole area is divided into four areas, the whole area may be divided into any arbitrary number of areas. In response to a video signal and a field-synchronizing signal, the LCD driver 108 drives the LCD panel 109 to form an image. In response to a field synchronizing signal, the backlight drive control unit 106 drives the LED groups 101-104 as divided into four areas in the light source 100 so that these are turned on and off sequentially in synchronization with a period of one field. The photosensor 107 detects a light yield of the light source 100, and feeds it back to the light source drive control unit 106.

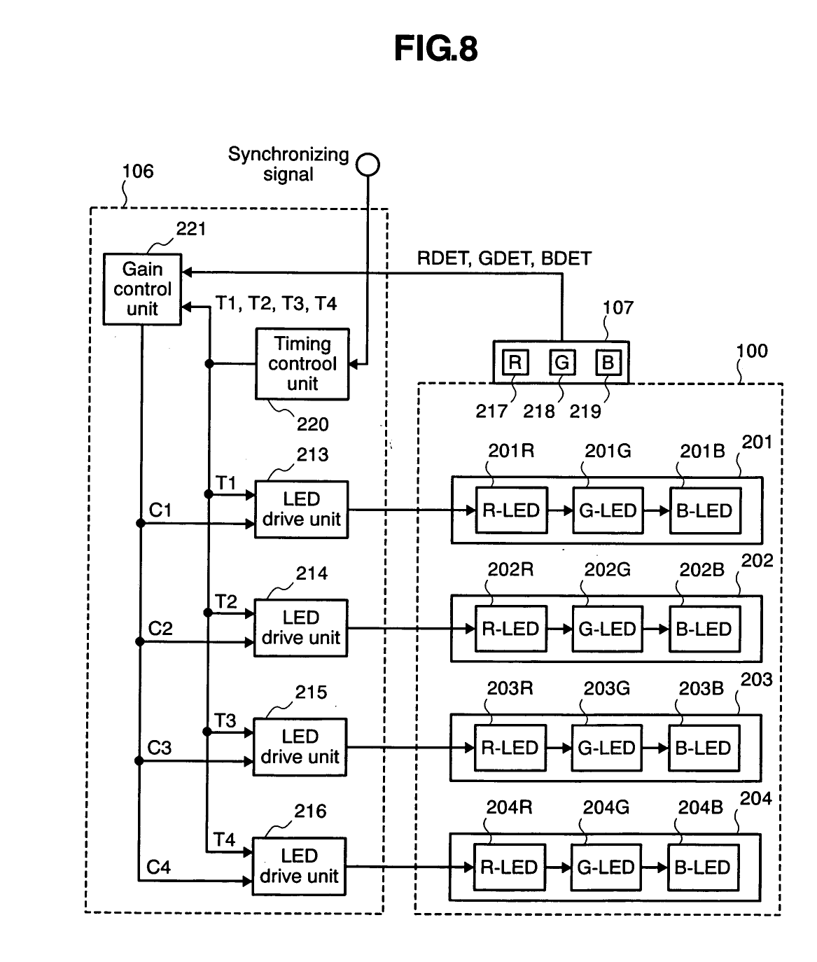

Each of the above-mentioned LED groups 101-104 that act as light sources includes three kinds of LED's each for emitting light of one of RGB colors. One concrete example of drive control of such a light source will be explained using FIG. 9. FIG. 8 shows details of a control system that is composed of the light source 100, the light source drive control unit 106, and the photosensor 107 shown in FIG. 7. The photosensor 107 is equipped with a red-light receiving part 217 for detecting red light, a green-light receiving part 218 for detecting green light, and a blue-light receiving part 219 for detecting blue light.

Each of LED groups 201-204 is composed of three colors of LED's: R-LED's that are R-light emitting LED's, G-LED's that are G-light emitting LED's, and B-LED's that are B-light emitting LED's. The R-LED subgroup of the LED group 201 is designated as 201R, the G-LED subgroup of the LED group 201 as 201G, and the B-LED subgroup of the LED group 201 as 201B. The designation is also done similarly for the LED groups 202-204. The each LED subgroup shall have required number of light-emitting diodes.

The light source drive control unit 106 is composed of LED drive units 213-216, a timing control unit 220, and again control unit 221. The LED drive units 213-216 control turning-on/off of three-color LED's of the respective LED groups 201-204. The timing control unit 220 generates timing signals for specifying turning-on/off by the LED drive units 213-216, and supplies these to the LED drive units 213-216. This timing signal is, for example, a signal with a pulse width that is a quarter of one vertical period of video signal, which is supplied to the LED drive units 213-216 sequentially. Therefore, the LED drive unit 213 operates in the first quarter of one vertical period that is a quartered vertical period, the LED drive unit 214 operates in the next second quarter, the LED drive unit 215 operates in the third quarter, and the LED drive unit 216 operates in the fourth quarter. By this, sequential turning-on/off of the LED groups of the light source 100 can be realized.

The gain control unit 221 controls gains of driving signals that determine the light yields of LED's when the LED drive units 213-216 drive the LED groups 201-204, and thereby controls the light yields of the LED's. Moreover, detection signals of the light yields of R, G, and B colors from the photosensor 107 and a timing signal from the timing control unit 220 are guided to the gain control unit 221. The gain control unit 221 generates a light yield detection signal for each period by sampling the light yield detection signals of R, G, and B from the photosensor 107 at each time of switchover of the timing signal from the timing control unit 220, and performs the above-mentioned gain control based on this information.

This embodiment features the following respects in the projection type display device as described above. (1) The projection type display device has an optical filter member for selectively absorbing (attenuating) external lights, especially lights having peak wavelengths of R, G, and B colors among lights emitted from the three-wavelength fluorescent lamp. (2) Peak wavelengths of lights from at least the G-LED or both the G-LED and the R-LED, among the above-mentioned R-LED, G-LED, and B-LED, are different from peak wavelengths of R, G, and B colors of the three-wavelength fluorescent lamp.

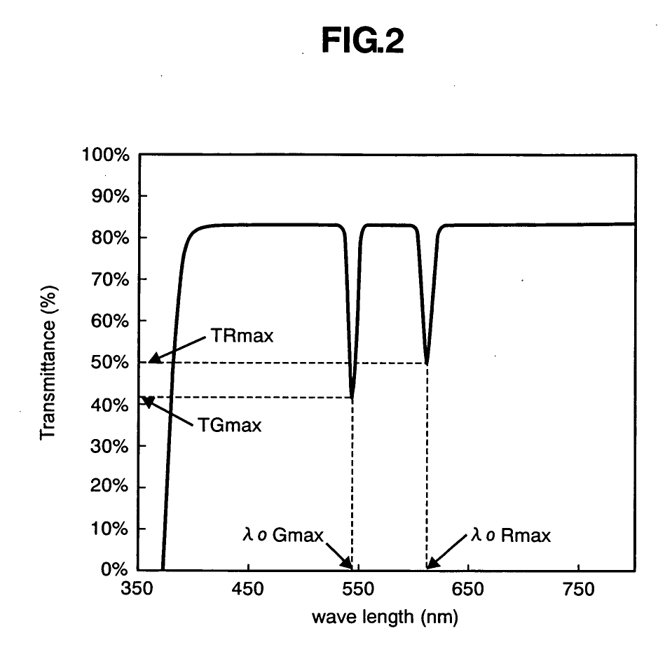

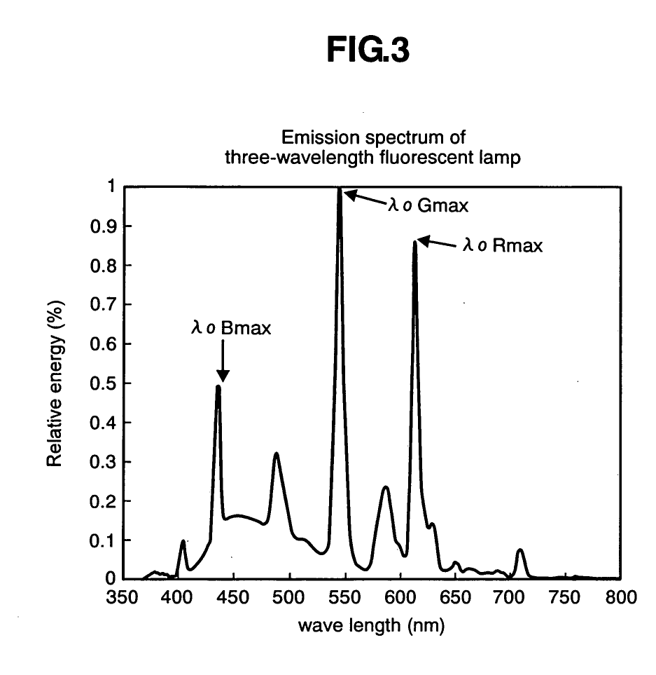

First, the above-mentioned (1) optical filter member will be explained with reference to FIGS. 2 to 4. To begin with, a general emission characteristic of the three-wavelength fluorescent lamp will be explained. FIG. 3 shows an emission spectrum distribution of the three-wavelength fluorescent lamp that is typical as the external light with a horizontal axis representing the wavelength of light and the vertical axis representing the relative energy of light. As is clear from FIG. 3, the G-light (green light) with a high visibility has an energy peak in the vicinity of 545 nm. Hereafter, a peak wavelength of this G-light is designated by λoGmax. The R-light with a high visibility next to the G-light has an energy peak in the vicinity of 615 nm. Hereafter, a peak wavelength of this R-light is designated by λoRmax. The B-light with the lowest visibility has an energy peak in the vicinity of 440 nm. Hereafter, the peak wavelength of this B-light is designated by λoBmax. Moreover, a peak exists also in the vicinity of 490 nm. In the case where the projection type display device is used under a three-wavelength fluorescent lamp having such an emission characteristic, if the transmission type screen 30 of the projection type display device is provided with an optical filter member for selectively attenuating lights of the above-mentioned peak wavelengths, the reduction in contrast can be prevented by controlling external light reflection on the transmission type screen 30 excellently.

FIG. 2 shows one example of a filter characteristic of the optical filter member according to this embodiment, namely a transmittance characteristic. In the characteristic shown in FIG. 2, the horizontal axis represents wavelength of light and the vertical axis represents transmittance. The optical filter member according to this embodiment has absorption bands of light at the G-peak wavelength λoGmax (545 nm) of the three-wavelength fluorescent lamp and at the R-peak wavelength λoRmax (615 nm) of the three-wavelength fluorescent lamp. The transmittance at λoGmax is TGmax (42%), and that at λoRmax is TRmax (50%). The transmittance in the visible region other than the two peak wavelengths is substantially 83%. Moreover, the optical filter member is added with an ultraviolet absorbent so that lights in an ultraviolet light region of 400 nm or less do not pass through. The transmittance at 375 nm or less is substantially 0%. Note that, the optical filter member according to this embodiment is not provided with an absorption band of light in the vicinity of B-peak wavelength λoBmax (440 nm). The reason is that, since the B-light has a low visibility, reflection of the B-light does not have a large effect on the reduction in contrast. However, it is needles to say that an absorption band of light maybe provided in the vicinity of the B-peak wavelength. Moreover, an absorption band of light is not provided for the peak wavelength in the vicinity of 490 nm because of a low visibility. In the example of the characteristic of the optical filter member described above, the absorption bands of light are provided for the G-peak wavelength and the R-peak wavelength. However, the absorption band of light may be provided only for G-peak wavelength which the highest visibility.

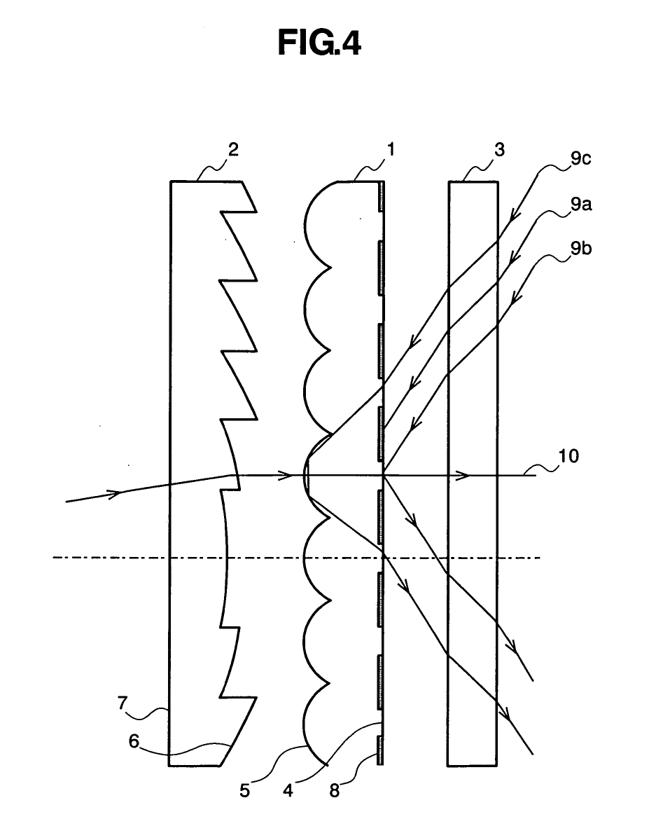

FIG. 4 shows one example of a structure of a transmission type screen in which the above-mentioned optical filter member is used. This transmission type screen has a Fresnel lens sheet 2, a lenticular lens sheet 1 disposed on the image observation side of the Fresnel lens sheet 2, and a front protective sheet 3 disposed on the image observation side of the lenticular lens sheet 1. The Fresnel lens sheet 2 is equipped with a concentric Fresnel lens 6 on its light exit plane and, by this Fresnel lenses 6, collimates a beam of image light entering from an image-light entrance plane 7 into an almost parallel beam, and lets it go out. By this conversion, the brightness of the whole image plane of the transmission type screen is made uniform. On the light entrance plane of the lenticular lens sheet 1, lenticular lenses 5 are elongated in vertical direction and arranged in horizontal direction. By a converging effect of these lenticular lenses 5, the image light exiting from the Fresnel lens sheet 2 is refracted and diffused in the horizontal direction. Moreover, light transmission parts 4 are formed on a light exit plane of the lenticular lens sheet 1 in the vicinity of a focal point of the lenticular lenses 5. By this structure, light focused by the lenticular lenses 5 is made to exit from the light transmission parts 4 and is diffused in the horizontal direction. Furthermore, a black-colored black stripe 8 extending to the screen vertical direction is provided between the light transparent parts 4 in the light exit plane of the lenticular lens sheet 1. The black stripe 8 absorbs external light and suppresses external light reflection on the light exit plane of the lenticular lens sheet 1. The front protective sheet 3 is for protecting the light transmission parts 4 and the black stripe 8 from physical contact from the outside, usually having a larger thickness than the lenticular lens sheet 1. Although the lenticular lens sheet 1 and the front protective sheet 3 are separated in the example shown in the figure, the two constituents may be combined into one piece to construct a single front sheet. In addition, although not illustrated, a light diffusion material may be mixed into the lenticular lens sheet 1 and/or the front protective sheet 3, so that the angle of field is further widened.

In the screen of such a structure, portions of external lights 9a, 9b, and 9c, such as indoor illumination light (three-wavelength fluorescent lamp), pass through the front protective sheet 3, and the portion 9a is absorbed by the optical absorption layer 8 provided on the exit plane side of the lenticular lens sheet 1. Moreover, other portions 9b, 9c are reflected by the light transmission parts 4 of the lenticular lens sheet 1 and the entrance plane of the lenticular lenses 5, pass through the front protective sheet 3, and return to the outside. These returned external lights 9b, 9c overlap an image light 10A exiting from the front protective sheet 3, thus becoming one contributing factor of reducing the contrast of the image. In order to prevent such reduction in contrast, in this embodiment, the above-mentioned front protective sheet 3 is provided with an optical filter member having a transmittance characteristic shown in FIG. 2. Specifically, the front protective sheet 3 is rendered to have a transmittance characteristic shown in FIG. 2 by mixing a dye or pigment into the front protective sheet 3. Therefore, for example, the intensity of an external light having the G-peak wavelength (λoGmax) is attenuated to 42% when passing through the front protective sheet 3 and reaching the lenticular lens sheet 1. When the external light is reflected at several parts of the lenticular lens sheet 1, passes through the front protective sheet 3, and returns to the outside, it is further attenuated to 42% of the attenuated light. Therefore, the intensity of the external light of the G-peak wavelength that makes a round trip in the front protective sheet 3 and exits from the front protective sheet 3 is attenuated to 17.6% of the intensity when entering the front protective sheet 3 from the outside. Moreover, since the transmittance characteristic of the optical filter member shown in FIG. 2 has a transmittance of approximately 50% to the red peak wavelength (λoRmax), the intensity of the external light of the R-peak wavelength that makes a round trip in the front protective sheet 3 and exits from the front protective sheet 3 is attenuated to 25% similarly. On the other hand, lights of wavelengths in the visible light region other than λoGmax and λoRmax are hardly attenuated, exhibiting a transmittance of substantially 83%.

Thus, the transmission type screen according to this embodiment has an optical filter element for selectively absorbing peak wavelength components having a high visibility among lights emitted from the three-wavelength fluorescent lamp. Because of this, reduction in contrast can be prevented by reducing external light reflection excellently. In the above mentioned example, the front protective sheet 3 is rendered to have a desired transmittance characteristic by mixing a dye or pigment into it. However, a wavelength selective film having a transmittance characteristic shown in FIG. 2 may be glued on the image observation side surface of the front protective sheet 3. In the case where the lenticular lens sheet 1 and the front protective sheet 3 are combined to constitute a front sheet, a wavelength selective film having a transmittance characteristic shown in FIG. 2 maybe glued on the front protective sheet 3. Furthermore, if there is no front protective sheet 3, the lenticular lens sheet 1 may be provided with an optical filter element.

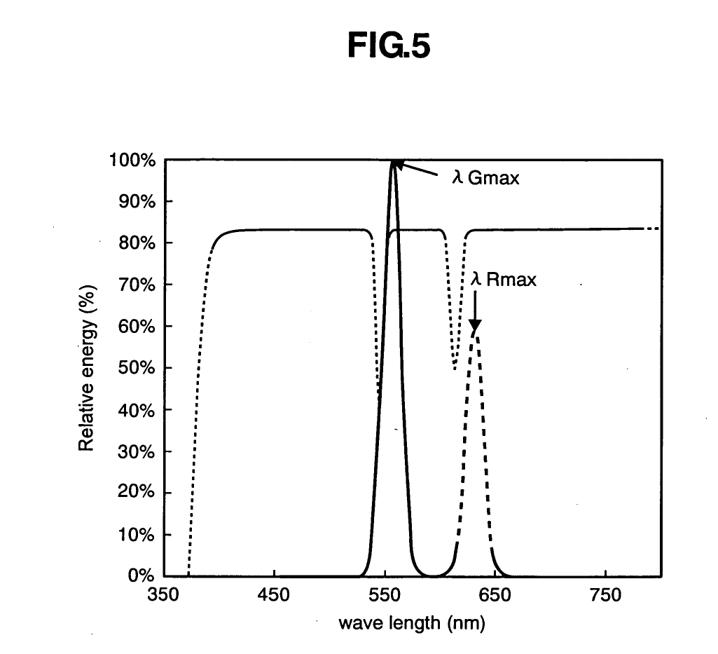

Next, the above-mentioned (2) will be explained. In the case where the wavelength selective filter is used having a transmittance characteristic shown in FIG. 2 described above, even the image light will be absorbed if peak wavelengths of RGB colors of image light (especially, peak wavelengths of G and R colors) are almost equal to the wavelengths for which an absorption band of the optical filter member is provided, i.e., λoGmax and λoRmax. In this case, although external light reflection is reduced, the brightness of an image is also decreased simultaneously. In order to prevent this, as a light source used to form an image, a light source for emitting lights whose peak wavelengths are different from λoGmax and λoRmax is selected in this embodiment. In order to make this selection easy, LED's of three colors are used in this embodiment as the light source, as described above. Specifically, as shown in FIG. 5, a primary wavelength λGmax of the peak energy of the G-light emitted from the G-LED is made to be a peak wavelength different from λoGmax (545 nm), for example, approximately 550 nm. Moreover, a primary wavelength λRmax of the peak energy of the R-light emitted from the R-LED is made to be a peak wavelength different from λ oRmax (615 nm), for example, approximately 630 nm. Setting up wavelengths in this way, the transmittances to λGmax and λRmax are both approximately 83%, indicating that the image light is hardly attenuated by the absorption band of the optical filter member, as is clear from FIG. 2.

As typical G-LED's currently on the market, for example, there are SLR343ECT (λGmax: 523 nm), SLR343BDT (λGmax: 518 nm), this SLA-360MT (λGmax: 560 nm), all made from ROHM CO., LTD., and the like. Moreover, as typical R-LED's currently on the market, for example, there are SLI-343YC (λRmax: 591 nm) made from ROHM, GL32RB02BOSE. (λ Rmax: 638 nm) made from SHARP CORPORATION, and the like. Therefore, what is necessary is just to suitably choose LED's whose peak wavelengths are different from the peak wavelengths, λoGmax and λoRmax, of G and R colors of the three-wavelength fluorescent lamp, respectively, from among these. A difference of λGmax to λoGmax may be determined depending on a range of the absorption band of the optical filter characteristic. For example, if the range of the absorption band (a range of transmittance of 70% or less) including λoGmax is 540 to 560 nm, a G-LED with λGmax=518 nm may be chosen. Similarly, if the range of the absorption band (for example, a range of transmittance of 70% or less) including λoRmax is 600 to 640 nm, a R-LED with λRmax=591 nm may be chosen.

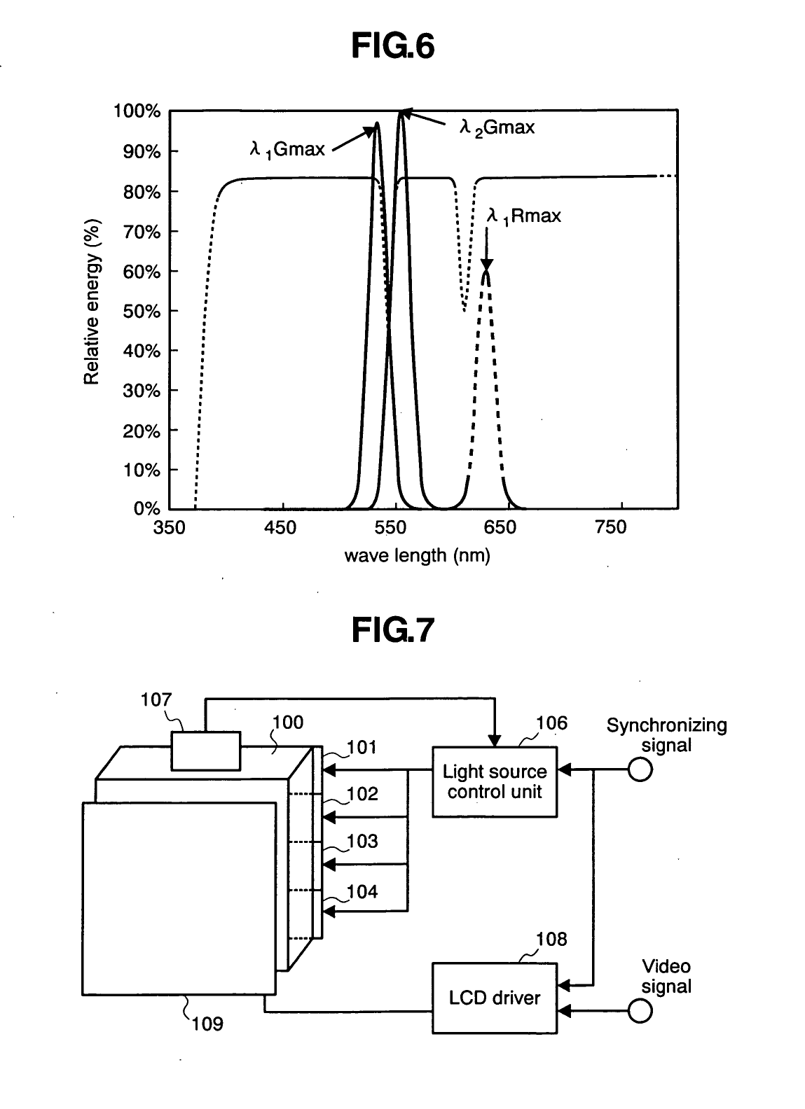

In FIG. 5, although the peak wavelength of each LED was assumed single, the peak wavelengths may be two or more as long as these differ from λoGmax and λoRmax. In the LED described previously, there is a case where LED's having a plurality of emission wavelengths are used being combined because a wavelength width of the emission spectrum of one LED is very narrow. As shown in FIG. 6, a combination of LED's whose peak wavelengths are λ₁Gmax, λ₂Gmax, and λ₁Rmax, respectively, yields the same effect if coincidence of these wavelengths with λoGmax and λ oRmax is avoided, regardless of the number of LED's.

In the above-mentioned embodiment, the rear projection type image display device that uses LED's as a light source and uses a liquid crystal panel as a display element was explained as an example of the image display device. However, the same effect can also be obtained with the image display device that uses any of a PDP, an FED, an SED (Surface-conduction Electron-emitter Display), and a direct view cathode-ray tube as a display element. That is, when using the PDP, FED, or SED, what is necessary is just to glue a wavelength selective filter as shown in FIG. 2 to a display surface glass of the panel.

In this way, according to this embodiment, the transmission type screen is provided with the optical filter member, and the LED's that emit lights whose peak wavelengths are different from peak wavelengths of G-light and R-light of the three-wavelength fluorescent lamp are used as a light source. For this reason, reduction in the contrast by external light reflection can be prevented, while controlling decrease in the brightness of an image.

What is claimed is:

1. An image display device, having the following configuration comprising:
a light source that emits lights, a peak wavelength of at least one specific color among peak wavelengths of red, blue, and green in an emission spectrum distribution being different from a peak wavelength of the specific color in an emission spectrum distribution of external light; and
a display element for forming an image by modulating lights from the light source.

2. The image display device according to claim 1, wherein
the specific color is green.

3. The image display device according to claim 1, wherein
the specific colors are green and red.

4. The image display device according to claim 1, wherein
the light source includes at least three kinds of light-emitting diodes for emitting three colors of lights of red, blue, and green.

5. The image display device according to claim 4, wherein
the external light is light from a three-wavelength fluorescent lamp, and a peak wavelength of a light emitted from an LED of at least one specific color among the LED's of three colors is different from a peak wavelength of the specific color in an emission spectrum distribution of the three-wavelength fluorescent lamp.

6. An image display, having the following configuration comprising:
a light source that includes at least three kinds of light-emitting diodes for emitting three colors of lights of red, blue, and green;
a peak wavelength of a light emitted from a light-emitting diode of at least one specific color among the light-emitting diodes of the three colors being different from a peak wavelength of the specific color in an emission spectrum distribution of the three-wavelength fluorescent lamp acting as external light; and
a display element for forming an image by modulating lights from the light source.

7. The image display device according to claim 6, wherein
an optical filter member that absorbs at least a light having a peak wavelength of the specific color in the emission spectrum distribution of the three-wavelength fluorescent lamp more largely than a light from a light-emitting diode of the specific color is provided on the display surface on which an image formed by the display element.

8. The image display device according to claim 7, wherein
the image display device is a projection type display device that enlarges and projects an image formed by the display element on its screen as a display surface.

9. The image display device according to claim 8, wherein
the screen includes a Fresnel lens sheet in which a Fresnel lens is formed, a front sheet for diffusing light at least in a horizontal direction and the optical filter member is provided on the front sheet.

10. The image display device according to claim 8, wherein
the screen includes a Fresnel lens sheet in which a Fresnel lens was formed, a front sheet for diffusing light at least in a horizontal direction, and a front protective sheet disposed on the image observation side of the front sheet, and the optical filter member is provided on the front protective sheet.

11. The image display device according to claim 8, wherein
a wavelength selective film acting as the optical filter member is glued on the surface of the screen.

12. An image display device, having the following configuration comprising:
a display element for forming an image; and
an optical filter member that is provided on a display surface on which an image formed by the display element is displayed, selectively attenuates at least one light having a peak wavelength of a specific color among peak wavelengths of red, blue, and green in a emission spectrum distribution of a three-wavelength fluorescent lamp, and absorbs peak wavelengths different from a peak wavelength of a specific color in an emission spectrum distribution of the display element.

13. The image display device according to claim 12, wherein
the display element is a liquid crystal element for modulating lights emitted from light-emitting diodes of three colors of red, blue, and green.

14. The image display device according to claim 13, wherein
a light-emitting diode for emitting a light of the specific color among the light-emitting diodes of the three colors is made of a plurality light-emitting diodes that emit lights having a plurality of peak wavelengths adjacent to the peak wavelength of the specific color in the three-wavelength fluorescent lamp.

15. The image display device according to claim 13, the image display device being a projection type display device having a screen on which the image formed by the liquid crystal display element is enlarged and projected, wherein
the screen is provided with the optical filter member.

16. The image display device according to claim 13, wherein
a wavelength selective film acting as the optical filter member is glued on an image observation side surface of the liquid crystal display element.

17. The image display device according to claim 12, wherein
the image display element is a plasma display panel, and a wavelength selective film acting as the optical filter member is glued on an image observation side surface of the plasma display panel.

18. The image display device according to claim 12, wherein
the display element is an electron or field emission type display element, and the wavelength selective film acting as the optical filter member is glued on the image observation side surface of the display element.
